(19) United States
(12) Patent Application Publication
(10) Pub. No.: US 2012/0020857 A1
(43) Pub. Date: Jan. 26, 2012

(54) DOSING SYSTEM HAVING RECIRCULATION HEATING AND VACUUM DRAINING

(76) Inventors: Raymond Upano ISADA, Peoria, IL (US); Yongxiang Li, Peoria, IL (US)

(21) Appl. No.: 12/840,383

(22) Filed: Jul. 21, 2010

(51) Int. Cl. B01D 53/94; F01N 3/20; F01N 11/00; B01D 50/00

(52) U.S. Cl. 423/212; 422/169; 60/276; 60/295

(57) ABSTRACT

A reductant dosing system is disclosed. The reductant dosing system may have a supply of reductant, a reductant nozzle, and a pump with an inlet and an outlet. The reductant dosing system may also have a first passage connecting the supply with the inlet of the pump, and a first control valve disposed in the first passage. The reductant dosing system may further have a second passage connecting the outlet of the pump with the reductant nozzle, and a second control valve disposed in the second passage. The reductant dosing system may additionally have a third passage connecting the second control valve to the first passage at a location downstream of the first control valve, and a fourth passage connecting the second control valve with the supply.

### TECHNICAL FIELD

The present disclosure is directed to a dosing system, and more particularly, to a reductant dosing system having recirculation heating and vacuum draining.

### BACKGROUND

Internal combustion engines, including diesel engines, gasoline engines, gaseous fuel-powered engines, and other engines known in the art exhaust a complex mixture of air pollutants. These air pollutants are composed of gaseous compounds including, among other things, the oxides of nitrogen (NOₓ). Due to increased awareness of the environment, exhaust emission standards have become more stringent, and the amount of NOₓ emitted to the atmosphere by an engine may be regulated depending on the type of engine, size of engine, and/or class of engine.

In order to comply with the regulation of NOₓ, some engine manufacturers have implemented a strategy called selective catalytic reduction (SCR). SCR is an exhaust treatment process where a reductant, most commonly urea ((NH₂)₂CO) or a water/urea solution, is selectively injected from an onboard supply into the exhaust gas stream of an engine and adsorbed onto a downstream substrate. The injected urea solution decomposes into ammonia (NH₃), which reacts with NOₓ in the exhaust gas to form water (H₂O) and diatomic nitrogen (N₂).

Although effective at reducing NOₓ in the exhaust flow of an engine, reductant dosing can be complicated and difficult to control. In particular, reductant may only be injected into the exhaust flow periodically and, after engine shutdown or between injection events, residual reductant left in system passages can boil, freeze, or otherwise leave deposits that inhibit flow during a subsequent injection event. In addition, the onboard supply of reductant can freeze and thereby make making injection impossible.

One attempt to reduce the likelihood of reductant clogging in a dosing system is disclosed in U.S. Patent Application Publication 2010/0122521 of Sun et al. that was published on May 20, 2010 (“the '521 publication”). Specifically, the '521 publication discloses a method of purging a dosing system utilizing pressurized air that is also used to assist reductant dosing. The method includes opening an air valve in an purge supply line between an air source and a reductant nozzle, opening a return valve in a purge passage between the reductant nozzle and a reductant source, and turning off a reductant pump. In this configuration, pressurized air is allowed to flow from the air source through the reductant nozzle and push residual reductant in the reductant nozzle back to the reductant source, thereby purging the reductant nozzle and associated supply lines.

The reductant dosing system of the present disclosure addresses one or more of the needs set forth above and/or other problems of the prior art.

### SUMMARY

In accordance with one aspect, the present disclosure is directed toward a reductant dosing system. The reductant dosing system may include a supply of reductant, a reductant nozzle, and a pump having an inlet and an outlet. The reductant dosing system may also include a first passage connecting the supply with the inlet of the pump, and a first control valve disposed in the first passage. The reductant dosing system may further include a second passage connecting the outlet of the pump with the reductant nozzle, and a second control valve disposed in the second passage. The reductant dosing system may additionally include a third passage connecting the second control valve to the first passage at a location downstream of the first control valve, and a fourth passage connecting the second control valve with the supply.

In accordance with another aspect, the present disclosure is directed toward another reductant dosing system. This reductant dosing system may include a supply of reductant, a reductant nozzle, and a pump having an inlet and an outlet. The reductant dosing system may also include a first passage connecting the supply with the inlet of the pump, and a second passage connecting the outlet of the pump with the reductant nozzle. The reductant dosing system may further include a first control valve disposed within the first and second passages, and a second control valve disposed within the second passage. The reductant dosing system may additionally include a third passage connecting the second control valve with the supply.

According to still another aspect, the present disclosure is directed toward another reductant dosing system. This reductant dosing system may include a supply of reductant, a reductant nozzle, and a pump connected between the supply and the reductant nozzle. The reductant dosing system may also include at least one valve connected between the supply and the reductant nozzle, and a controller in communication with the reductant nozzle, the pump, and the at least one valve. The controller may be configured to operate the pump in a single direction and selectively open and close the reductant nozzle and the at least one valve to implement an injecting mode of operation, an airless draining mode of operation, and a recirculation heating mode of operation.

According to yet another aspect, the present disclosure is directed to a method of operating a reductant dosing system. The method may include drawing low-pressure reductant from a supply through an inlet of a pump, and directing pressurized reductant through an outlet of the pump to a nozzle to inject the reductant. The method may additionally include drawing reductant from the nozzle with the pump to vacuum drain the reductant dosing system, and inhibiting drawing low-pressure reductant from the supply during draining.

### BRIEF DESCRIPTION OF THE DRAWINGS

FIG. 1 is a pictorial illustration of an exemplary disclosed reductant dosing system during a first mode of operation;

FIG. 2 is a pictorial illustration of the reductant dosing system of FIG. 1 during a second mode of operation;

FIG. 3 is a pictorial illustration of the reductant dosing system of FIG. 1 during a third mode of operation;

FIG. 4 is a pictorial illustration of another exemplary disclosed reductant dosing system during a first mode of operation;

FIG. 5 is a pictorial illustration of the reductant dosing system of FIG. 4 during a second mode of operation; and

FIG. 6 is a pictorial illustration of the reductant dosing system of FIG. 4 during a third mode of operation.

### DETAILED DESCRIPTION

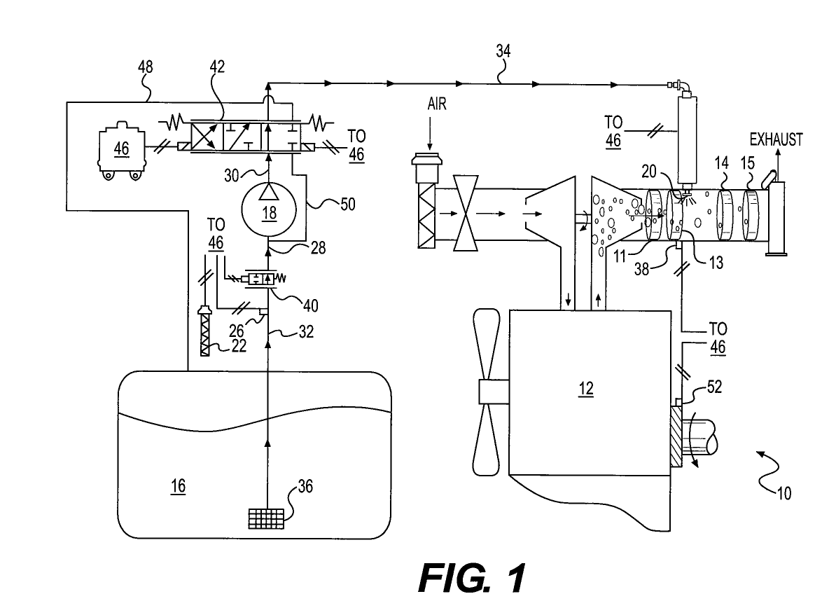

FIGS. 1-3 illustrate an exemplary reductant dosing system 10 that may be used with an engine 12. Engine 12 may be a combustion engine that combusts a mixture of fuel and air to produce a mechanical power output and a flow of exhaust. The exhaust flow from engine 12 may be directed through a series of aftertreatment components to the atmosphere, for example, through an oxidation catalyst 11 where conversion of NO to NO₂ may occur, a particulate filter 13 where solid particulate matter may be removed from the exhaust flow, a reduction catalyst 14 where one or more constituents in the exhaust flow may be reduced to harmless substances, and a cleanup catalyst 15 where residual reductant may be removed from the exhaust flow. Reductant dosing system 10 may be configured to supply reductant into the exhaust flow upstream of one or more of the aftertreatment components to facilitate exhaust conditioning within the aftertreatment components.

As shown in the embodiment of FIG. 1, reductant dosing system 10 may be configured to inject reductant into the engine's exhaust upstream of reduction catalyst 14 to affect the reducing chemical reaction. In one embodiment, reductant dosing system 10 may inject a urea solution into the exhaust of engine 12 to affect selective catalytic reduction (SCR). The urea solution may include water (H₂O) and urea ((NH₂)₂CO). At temperatures higher than about 180° C., the urea solution may decompose into ammonia (NH₃), which is used to convert NOₓ (NO and NO₂) in the exhaust flow of engine 12 to diatomic nitrogen (N₂) and water (H₂O). Reductant dosing system 10 may include a supply 16 of reductant, a pump 18 configured to draw reductant from supply 16 and pressurize the reductant, and a reductant nozzle 20 configured to inject the pressurized reductant.

Supply 16 may embody, for example, a working or buffer tank that, in some arrangements, is fluidly connected to another larger and remotely located tank (not shown). Supply 16 may be configured to hold the reductant and be periodically replenished by the remotely located tank. A heater 22 such as an electric coil heater or an engine coolant heater may be associated with supply 16 and/or pump 18 to thaw and/or maintain the reductant in a thawed state. It is also contemplated that heater 22 or an additional heater (not shown) may be associated with passages 32, 34, 48, and/or 50, if desired, to help maintain any reductant (i.e., supplied or residual reductant) within these passages in a fluid state.

Pump 18 may be a metering pump such as, for example, a diaphragm pump, a centrifuge pump, a piston pump, or a rotary pump. Pump 18 may be electrically operated in a single direction to draw low-pressure reductant from supply 16 through an inlet 28, to pressurize the reductant to a desired level, and to discharge the pressurized reductant through an outlet 30. Inlet 28 of pump 18 may be connected to supply 16 by way of a first or supply passage 32, while outlet 30 may be connected to reductant nozzle 20 by way of a second or injection passage 34. It is contemplated that a check valve (not shown) may be located within one or both of supply and injection passages 32, 34, if desired, to help ensure a unidirectional flow of reductant from supply 16 through pump 18. A filter 36, for example a metal screen, may also be associated with supply passage 32 and configured to remove ice crystals, urea crystals, and/or other debris from the reductant before it is received by pump 18. An supplementary filter (not shown) may be located within passage 32 to help remove additional debris from the reductant upstream of pump 18, if desired.

Reductant nozzle 20 may be located upstream of reduction catalyst 14 and configured to atomize and inject reductant into the exhaust flowing through reduction catalyst 14 without the use of assist air. In one example, a mixer (not shown) may be located in the exhaust flow of engine 12, between a urea injection location and reduction catalyst 14, if desired. Reductant nozzle 20 may embody a spray nozzle having a valve element (not shown) that is movable from a closed position to an open position. When the valve element of reductant nozzle 20 is in the open position and supplied with pressurized reductant from pump 18, the reductant may be directed through one or more orifices that atomize and inject the atomized reductant into the exhaust entering reduction catalyst 14. When the valve element of reductant nozzle 20 is in the closed position, reductant injections may be inhibited.

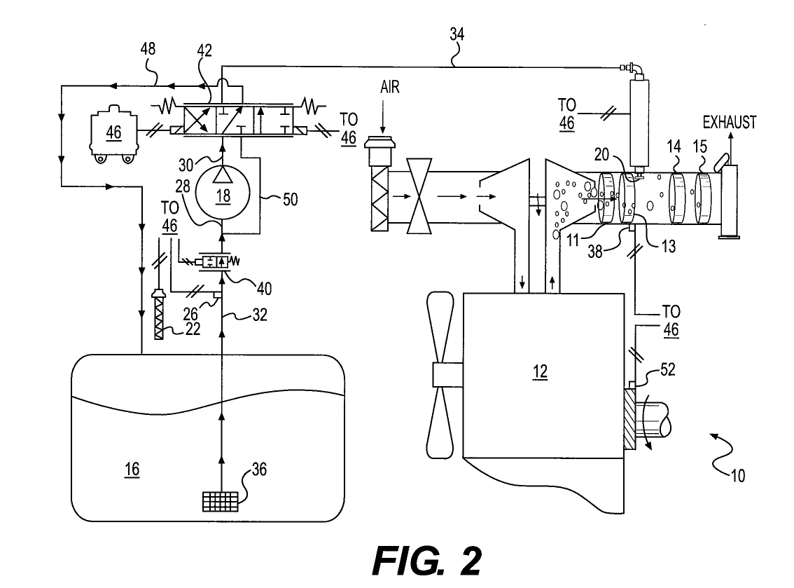

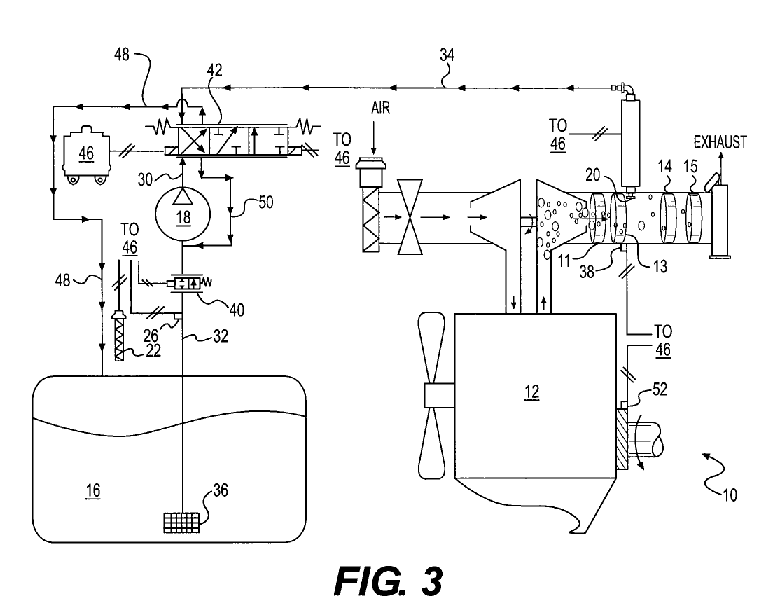

Multiple control valves may be disposed between supply 16 and reductant nozzle 20 to regulate different flows of reductant. In particular, a first control valve 40 is illustrated as being located within supply passage 32 and between supply 16 and pump 18, while a second control valve 42 is illustrated as being located within injection passage 34 and between pump 18 and reductant nozzle 20. Each of first and second control valves 40, 42 may include solenoid-actuated and spring-biased valve elements that are movable between different positions based on signals from a controller 46. Specifically, first control valve 40 may be a two-position, two-way valve, where the corresponding valve element is movable from a first position (shown in FIG. 1) at which fluid flow through supply passage 32 is allowed, to a second position (shown in FIG. 3) at which fluid flow through supply passage 32 is inhibited. Second control valve 42 may be a three-position, 4-way valve. At a first position (shown in FIG. 1), the valve element of second control valve 42 may allow fluid flow from only pump 18 to only reductant nozzle 20 via injection passage 34. At a second position (shown in FIG. 2), the valve element of second control valve 42 may allow fluid flow from only pump 18 back to only supply 16 via a third or recirculation passage 48. At a third position (shown in FIG. 3), the valve element of second control valve 42 may allow fluid flow from pump 18 back to only supply 16 via recirculation passage 48, and from reductant nozzle 20 back to only inlet 28 of pump 18 (i.e., to a suction side of pump 18) via a fourth or drain passage 50. It is contemplated that second control valve 42 may additionally include a fourth position, if desired, at which all flow through second control valve 42 is inhibited.

One or more sensors may be associated with reductant dosing system 10 to provide indications as to the operation of reductant dosing system 10. For example, a temperature sensor 26 may be associated with supply 16 and configured to generate a signal indicative of a temperature of the reductant mixture within supply 16. An exhaust sensor 38 may be associated with reduction catalyst 14 and configured to detect a concentration of a particular constituent (e.g., NOₓ) within the exhaust flow of engine 12 at a location upstream of reductant nozzle 20 and/or downstream of reduction catalyst 14. An engine sensor 52 may be associated with engine 12 and configured to provide a signal indicative of an operational status of engine 12 (e.g., whether engine 12 is on or off). One or more pressure sensors (not shown) may be associated with any of passages 32, 34, 48, and/or 50 and configured to provide a signal indicative of a pressure of reductant within these passages. A level sensor (not shown) may be associated with supply 16 and configured to provide a signal indicative of an amount of reductant remaining within supply 16 and/or a consumption rate of reductant. It is contemplated that additional and/or different sensors, for example a temperature or pressure sensor (not shown), may be associated with the exhaust flow of engine 12 and/or reductant dosing system 10, if desired.

Controller 46 may be in communication with first and second control valves 40, 42, pump 18, reductant nozzle 20, heater 22, sensors 26, 38, and 52, and other components of reductant dosing system 10, to regulate operation of these components in response to various input. Controller 46 may embody a single or multiple microprocessors, field programmable gate arrays (FPGAs), digital signal processors (DSPs), etc. that include a means for controlling an operation of reductant dosing system 10 in response to the input. Numerous commercially available microprocessors can be configured to perform the functions of controller 46. It should be appreciated that controller 46 could readily embody a microprocessor separate from that controlling other non-exhaust related power system functions, or that controller 46 could be integral with a general power system microprocessor and be capable of controlling numerous power system functions and modes of operation. If separate from the general power system microprocessor, controller 46 may communicate with the general power system microprocessor via datalinks or other methods. Various other known circuits may be associated with controller 46, including power supply circuitry, signal-conditioning circuitry, actuator driver circuitry (i.e., circuitry powering solenoids, motors, or piezo actuators), and communication circuitry.

Controller 46 may be configured to implement at least three distinct modes of operation for reductant dosing system 10, including a reductant injecting mode, a recirculation heating mode, and an airless or vacuum draining mode. These three modes of operation may be implemented by selective regulation of pump 18, first and second control valves 40, 42, and reductant nozzle 20. The modes of operation may be triggered by signals from sensors 26, 38, and 52. Operation of reductant dosing system 10 will be described in more detail in the following section.

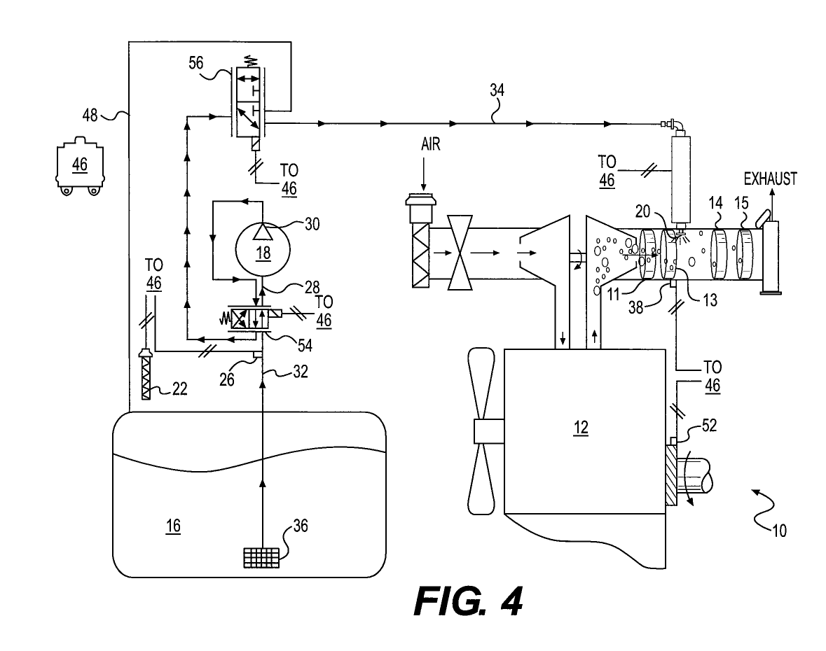

FIGS. 4-6 illustrate an alternative embodiment of reductant dosing system 10. Similar to the embodiment of FIGS. 1-3, reductant dosing system 10 of FIGS. 4-6 may include supply 16, pump 18, reductant nozzle 20, heater 22, and controller 46. However, in contrast to the embodiment of FIGS. 1-3, first and second control valves 40, 42 may be replaced with first and second control valves 54 and 56 in reductant dosing system 10 of FIGS. 4-6. In addition, drain passage 50 may be omitted in the embodiment of FIGS. 4-6.

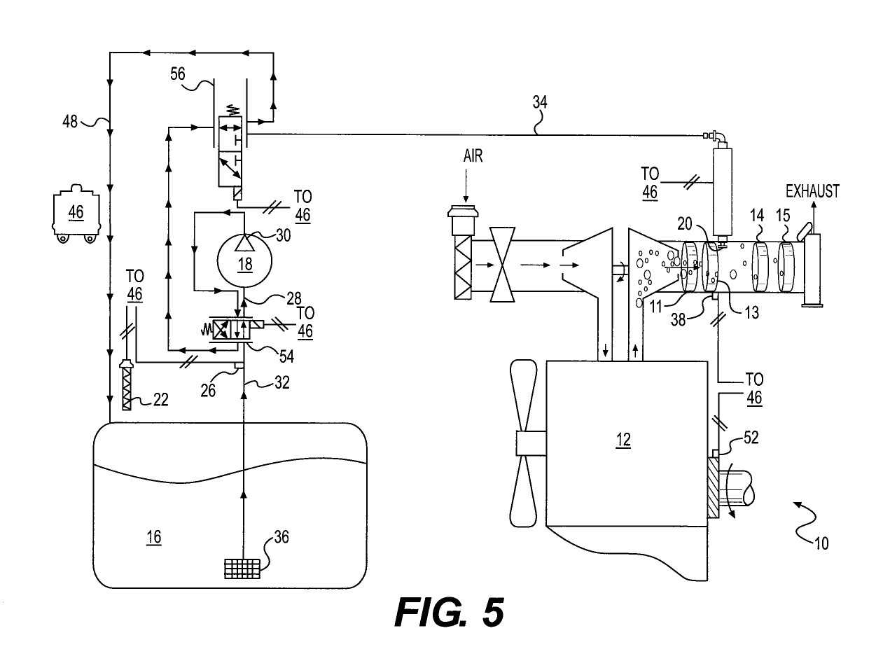

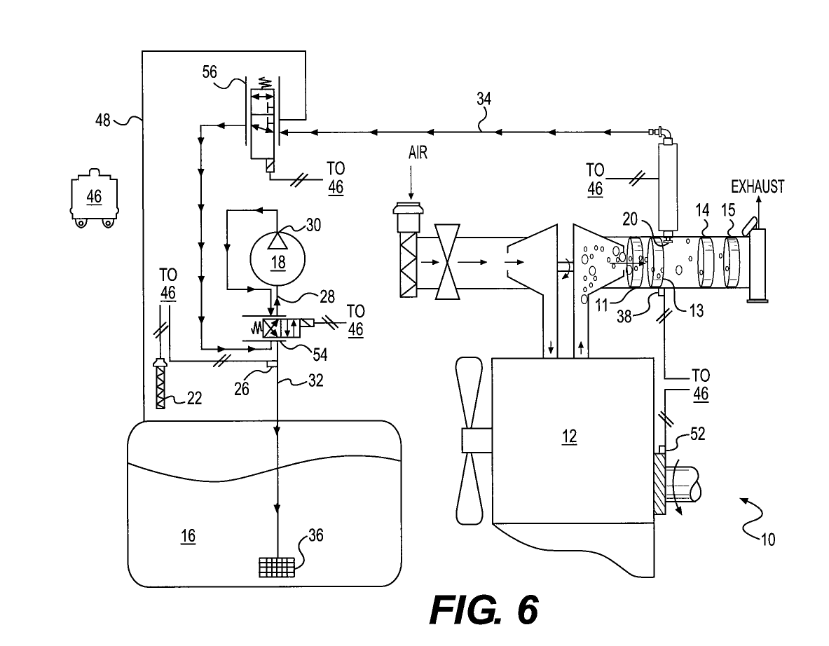

First control valve 54 is illustrated as being located within supply passage 32, between supply 16 and pump 18 and between pump 18 and reductant nozzle 20. Second control valve 56 is illustrated as being located within injection and recirculation passages 34, 48, between pump 18 and reductant nozzle 20 and between pump 18 and supply 16. Each of first and second control valves 54, 56 may include solenoid-actuated and spring-biased valve elements that are movable between different positions based on signals from controller 46. Specifically, first control valve 54 may be a two-position, four-way valve, where the corresponding valve element is movable from a first position (shown in FIG. 4) at which fluid flow through supply passage 32 in a first direction toward pump 18 is allowed, to a second position (shown in FIG. 6) at which fluid flow through supply passage 32 in a second direction toward supply 16 is allowed. Second control valve 56 may be a two-position, 3-way valve. At a first position (shown in FIG. 4), the valve element of second control valve 56 may allow fluid flow from only pump 18 to only reductant nozzle 20 via injection passage 34. At a second position (shown in FIG. 5), the valve element of second control valve 56 may allow fluid flow from only pump 18 back to only supply 16 via recirculation passage 48. It is contemplated that either or both of first and second control valves 54, 56 may include an additional position, if desired, at which all flow through first and/or second control valves 54, 56 is inhibited.

### INDUSTRIAL APPLICABILITY

The disclosed reductant dosing system may be used in any power system application where consistent and reliable reductant dosing is desired. The disclosed reductant dosing system may provide consistent and reliable reductant dosing by ensuring that reductant is available for injection (i.e., that appropriate amounts of reductant are thawed at desired injection timings) and that the passages and components of reductant dosing system are clear of potential blockages. Operation of reductant dosing system 10 will now be described.

During operation of engine 12, exhaust may be generated that includes an elevated concentration of a particular constituent, for example NOₓ. In response to detection of the elevated concentration by exhaust sensor 38 or, alternatively, based on known constituent production of engine 12 or another similar calculated, detected, or known parameter, controller 46 may implement the reductant injecting mode of operation (illustrated in FIG. 1). To implement the reductant injecting mode of operation, controller 46 may move the valve element of first control valve 40 to the first or flow-passing position, move the valve element of second control valve 42 to the first position, open reductant nozzle 20, and regulate pump 18 to draw in and pressurize reductant. The reductant drawn into pump 18 via supply passage 32 and inlet 28 may be discharged at an elevated pressure via outlet 30 and injection passage 34 to reductant nozzle 20, where reductant nozzle 20 may inject the pressurized reductant into the exhaust flow from engine 12. The injecting mode of operation may continue until a desired level of the detected constituent has been achieved, until a desired amount of reductant has been injected, until a desired time period has elapsed, or until another similar control parameter has been achieved.

In some situations, such as at startup of engine 12 or during operation of engine 12 in cold conditions, it may be possible for the reductant in supply 16 to freeze. In these situations, based on a signal from temperature sensor 26, controller 46 may trigger operation in the recirculation heating mode (illustrated in FIG. 2). For example, when temperature sensor 26 indicates that the temperature of the reductant within supply 16 or flowing through supply passage 32 is in the range of about −5° C. to −20° C., controller 46 may trigger the recirculating heating mode. To implement the recirculation heating mode of operation, controller 46 may move the valve element of first control valve 40 to the first or flow-passing position, move the valve element of second control valve 42 to the second position, close reductant nozzle 20, and regulate pump 18 to draw in and pressurize reductant. The reductant drawn into pump 18 via supply passage 32 and inlet 28 may be discharged at an elevated pressure from outlet 30 and flow through second control valve 42 and recirculation passage 48 back to supply 16. The work performed by pump 18 to pressurize and move reductant through recirculation passage 48 may warm the reductant and thereby help to thaw or maintain the reductant in a thawed state. In addition to recirculating the reductant, controller 46 may also energize heater 22, if desired. For example, when no liquid reductant is available for recirculation (i.e., when all reductant is completely frozen), controller 46 may first energize heater 22 and then delay a period of time before implementing recirculation of reductant. The period of time delay, in one embodiment, may be associated with a detected temperature or pressure of the reductant within supply 16 or supply passage 32. After a sufficient amount of reductant has been melted by heater 22, recirculation of the melted reductant may enhance thawing of the remaining frozen reductant within supply 16. The recirculation heating mode of operation may continue until a desired reductant temperature or pressure has been achieved, until a desired time period has elapsed, or until another similar control parameter has been achieved.

Reductant nozzle 20 and/or particular passages of reductant dosing system 10 may need to be periodically drained of residual reductant to help ensure success in subsequent injection events (i.e., to help reduce the risk of blockage during injection events). Accordingly, in response to a signal from engine sensor 52 indicating a particular operational status of engine 12 (e.g., in response to a signal indicating that engine 12 has been shutdown or restarted), controller 46 may trigger the draining mode of operation (illustrated in FIG. 3). Alternatively or additionally, the draining mode of operation may be implemented in response to an elapsed period of time following an injection event, for example five minutes. To implement the draining mode of operation, controller 46 may move the valve element of first control valve 40 to the second or flow-blocking position, move the valve element of second control valve 42 to the third position, close reductant nozzle 20, and regulate pump 18 to draw in and pressurize reductant. The reductant drawn into pump 18 during this mode of operation, because first control valve 40 is closed, may come only from reductant nozzle 20, injection passage 34, and drain passage 50. That is, during the draining mode of operation, pump 18 may function as a vacuum pump, sucking in residual reductant and depositing the residual reductant in supply 16 via recirculation passage 48. The draining mode of operation may continue until a desired pressure within reductant dosing system 10 is achieved, until a desired amount of reductant has been deposited in supply 16, until a desired time period has elapsed, or until another similar control parameter has been achieved. It is contemplated that any one or all of passages 32, 34, 48, and/or 50 may alternatively or additionally be drained of residual reductant via gravity, if desired. For example, when the valve element of second control valve 42 is in the first and/or second positions, reductant from passages 32, 34, 48, and 50, because of a relatively higher location above supply 16, may be allowed to drain into supply 16.

Reductant nozzle 20 may be closed during vacuum draining to help minimize the likelihood of debris from clogging nozzle 20 and/or injection passage. Specifically, if nozzle 20 were left open during the vacuum draining mode of operation, it might be possible for pump 18 to draw in contaminates from the exhaust flow of engine 12 that could lodge within nozzle 20 and/or injection passage 20. Accordingly, reductant nozzle 20 may be closed during the vacuuming performed by pump 18 to reduce the inflow of exhaust contaminates. It is contemplated, however, that nozzle 20 may be held open during the vacuum draining, if desired.

Because drain passage 50 may connect to supply passage 32 at a location upstream of pump 18, the draining mode of operation may be completed airlessly. That is, no specialized purge fluid may be required to drain the components and passages of reductant dosing system 10, because the system may be vacuum-drained. Airless draining may be beneficial, as the components normally required for pressurized purging can be eliminated, thereby eliminating the associated control complexity and unreliability.

With respect to the embodiment of FIGS. 4-6, controller 46 may implement the reductant injecting mode of operation by moving the valve elements of first and second control valves 54, 56 to their first positions shown in FIG. 4. At this time, reductant may be drawn by pump 18 from supply 16 via passage 32 and first control valve 54, and redirected back through first control valve 54 to second control valve 56. The pressurized reductant from pump 18 may pass through second control valve 56 to reductant nozzle 20, where the reductant may be subsequently injected.

Controller 46 may implement the recirculation heating mode of operation by moving the valve elements of first and second control valves 54, 56 to their respective first and second positions, as shown in FIG. 5. At this time, reductant from pump 18 may flow back to supply 16 via recirculation passage 48, the recirculating flow helping to heat and/or recirculate heated reductant within reductant dosing system 10.

Controller 46 may trigger the draining mode of operation by moving the valve elements of first and second control valves 54, 56 to their respective second and first positions, as shown in FIG. 6. At this time, although pump 18 may still be operating in the same direction as in the reductant dosing and recirculation heating modes of operation (i.e., pump 18 may always operate in a single direction), flow through injection and supply passages 32, 34 may be reversed such that residual reductant within reductant nozzle 20, injection passage 43, and supply passage 32 may be drained to supply 16 via first and second control valves 54, 56.

Because flow through supply and injection passages 32, 34 may be reversed, the draining mode of operation may be completed airlessly. As described above, airless purging may reduce or eliminate the need for specialized purge fluid and the components normally required for pressurized purging.

It will be apparent to those skilled in the art that various modifications and variations can be made to the disclosed reductant dosing system. Other embodiments will be apparent to those skilled in the art from consideration of the specification and practice of the disclosed reductant dosing system. For example, although first and second control valves 40, 42 have been shown and described as having a single solenoid-operated valve element, it is contemplated that one or both of first and second control valves 40, 42 may alternatively include two valve elements such as a pilot-operated element and a solenoid-operated element that controls a flow of pilot fluid, for example air, to move the pilot-operate element, if desired. Alternatively one or both of first and second control valves 40, 42 could include dual solenoids and/or dual springs located at opposing ends of a single or multiple valve elements, if desired. It is intended that the specification and examples be considered as exemplary only, with a true scope being indicated by the following claims and their equivalents.

What is claimed is:

1. A reductant dosing system, comprising:
a supply of reductant;
a reductant nozzle;
a pump having an inlet and an outlet;
a first passage connecting the supply with the inlet of the pump;
a first control valve disposed in the first passage;
a second passage connecting the outlet of the pump with the reductant nozzle;
a second control valve disposed in the second passage;
a third passage connecting the second control valve to the first passage at a location downstream of the first control valve; and
a fourth passage connecting the second control valve with the supply.

2. The reductant dosing system of claim 1, wherein the third passage is connected to the first passage at a location upstream of the pump.

3. The reductant dosing system of claim 1, wherein the first control valve is a two-position, two-way valve.

4. The reductant dosing system of claim 3, wherein the second control valve is a three-position, four-way valve.

5. The reductant dosing system of claim 4, wherein the first and second control valves are solenoid-operated and spring-biased.

6. The reductant dosing system of claim 1, further including at least one heater associated with at least one of the supply and the pump.

7. The reductant dosing system of claim 1, further including a controller in communication with the reductant nozzle, the pump, the first control valve, and the second control valve, the controller being configure to operate the pump in a single direction and selectively open and close the reductant nozzle, move the first control valve, and move the second control valve to implement an injecting mode of operation, an airless draining mode of operation, and a recirculation heating mode of operation.

8. The reductant dosing system of claim 7, further including:
an exhaust sensor configured to detect a constituent of an exhaust flow, wherein output of the exhaust sensor triggers implementation of the injecting mode of operation;
an engine sensor configured to detect an operational status of an associated engine, wherein output of the engine sensor triggers implementation of the draining mode of operation; and
a temperature sensor associated with the supply, wherein output of the temperature sensor triggers implementation of the recirculation heating mode of operation.

9. The reductant dosing system of claim 7, wherein the reductant nozzle includes an open position and a closed position, and the controller is configured to also affect movement of the reductant nozzle between the open and closed positions to implement the injecting mode of operation, the airless draining mode of operation, and the recirculation heating mode of operation.

10. A reductant dosing system, comprising:
a supply of reductant;
a reductant nozzle;
a pump having an inlet and an outlet;
a first passage connecting the supply with the inlet of the pump;
a second passage connecting the outlet of the pump with the reductant nozzle;
a first control valve disposed in the first and second passages;
a second control valve disposed in the second passage; and
a third passage connecting the second control valve with the supply.

11. The reductant dosing system of claim 10, wherein flow through the first and second passages is in a first direction during a first mode of operation and in a second direction opposite the first during a second mode of operation.

12. The reductant dosing system of claim 11, wherein the pump operates in a single direction during the first and second modes of operation.

13. The reductant dosing system of claim 10, wherein:
the first control valve is a two-position, four-way valve; and
the second control valve is a two position, three-way valve.

14. The reductant dosing system of claim 10, further including a controller in communication with the reductant nozzle, the pump, the first control valve, and the second control valve, the controller being configure to operate the pump in a single direction and selectively open and close the reductant nozzle, move the first control valve, and move the second control valve to implement an injecting mode of operation, an airless draining mode of operation, and a recirculation heating mode of operation.

15. The reductant dosing system of claim 14, wherein the reductant nozzle includes an open position and a closed position, and the controller is configured to also affect movement of the reductant nozzle between the open and closed positions to implement the injecting mode of operation, the airless draining mode of operation, and the recirculation heating mode of operation.

16. A reductant dosing system, comprising:
a supply of reductant;
a reductant nozzle;
a pump connected between the supply and the reductant nozzle;
at least one control valve connected between the supply and the reductant nozzle; and
a controller in communication with the reductant nozzle, the pump, and the at least one control valve, the controller configured to operate the pump in a single direction and selectively open and close the reductant nozzle and the at least one control valve to implement an injecting mode of operation, an airless draining mode of operation, and a recirculation heating mode of operation.

17. The reductant dosing system of claim 16, wherein the at least one control valve includes a first control valve disposed between the supply and the pump.

18. The reductant dosing system of claim 17, wherein the at least one control valve also includes a second control valve disposed between the pump and the reductant nozzle.

19. The reductant dosing system of claim 16, further including at least one heater associated with at least one of the supply and the pump.

20. The reductant dosing system of claim 16, further including:
an exhaust sensor configured to detect a constituent of an exhaust flow, wherein the injecting mode of operation is triggered based on output from the exhaust sensor;
an engine sensor configured to detect an operational status of an associated engine, wherein the airless draining mode of operation is trigged based on output from the engine sensor; and
a temperature sensor configured to detect a temperature of the supply, wherein the recirculation heating mode of operation is triggered based on output from the temperature sensor.

21. The reductant dosing system of claim 16, wherein the reductant nozzle includes an open position and a closed position, and the controller is configured to affect movement of the reductant nozzle between the open and closed positions to implement the injecting mode of operation, the airless draining mode of operation, and the recirculation heating mode of operation.

22. A method of operating a reductant dosing system, comprising:
drawing low-pressure reductant from a supply through an inlet of a pump;
directing pressurized reductant through an outlet of the pump to a nozzle to inject the reductant;
drawing reductant from the nozzle with the pump to vacuum drain the reductant dosing system; and
inhibiting drawing low-pressure reductant from the supply during draining.

23. The method of claim 22, further including:
heating the reductant; and
directing heated reductant through a recirculation passage to thaw reductant in the supply.

24. The method of claim 23, further including inhibiting reductant flow to the nozzle when directing heated reductant through the recirculation passage.

25. The method of claim 23, further including inhibiting flow through the recirculation passage during injecting.

26. The method of claim 23, further including gravity-draining at least one passage of the reductant dosing system.
